(19) United States
(12) Patent Application Publication
(10) Pub. No.: US 2026/0301238 A1
(43) Pub. Date: Oct. 1, 2026

(54) METHOD FOR ENCODING AND DECODING A 3D POINT CLOUD, ENCODER, DECODER

(71) Applicant: Beijing Xiaomi Mobile Software Co., Ltd., Beijing (CN)

(72) Inventor: Shuo GAO, Beijing (CN)

(21) Appl. No.: 19/475,550

(22) PCT Filed: Apr. 18, 2023
(86) PCT No.: PCT/CN2023/089070

§ 371 Date: Oct. 15, 2025

(51) Int. Cl. G06T 9/40; G06T 7/73; G06T 17/00

(52) U.S. Cl. CPC G06T 9/40; G06T 7/73; G06T 17/00; G06T 2207/10028; G06T 2210/56

(57) ABSTRACT

A method for decoding, from a bitstream, a geometry of a 3D point cloud, is implemented in a decoder. The method includes: receiving the bitstream, wherein the bitstream contains vertex information including information about a position of a vertex on edges of cuboids of leaf nodes of an octree structure of the point cloud; splitting a leaf node into sub-cuboids; and obtaining the vertex information about the sub-cuboids to determine points of the point cloud.

### CROSS-REFERENCE TO RELATED APPLICATION

The present application is a U.S. National Stage of International Application No. PCT/CN2023/089070, filed on Apr. 18, 2023, the contents of which are incorporated herein by reference in their entirety.

### TECHNICAL FIELD

The present disclosure relates to a method for encoding and decoding a 3D point cloud, encoder, decoder.

### BACKGROUND

As a format for the representation of 3D data, point clouds have recently gained traction as they are versatile in their capability in representing all types of 3D objects or scenes. However, as for all compression schemes, quality of reconstruction the points of the point cloud is essential.

### SUMMARY

Thus, it is an object of the present disclosure to provide a method for decoding geometry of a 3D point cloud from a bitstream as well as encoding of a 3D point cloud into a bitstream with increased efficiency.

The problem is solved by a method for decoding according to claim 1, a method for encoding according to claim 7, an encoder according to claim 12, a decoder according to claim 13, a bitstream according to claim 14 and a software according to claim 15.

In a first aspect a method for decoding geometry of a 3D point cloud from a bitstream is provided preferably implemented in a decoder. The method includes:
receiving a bitstream, wherein the bitstream contains vertex information including information about position of a vertex on edges of cuboids of leaf nodes of the octree structure of the point cloud;
splitting the leaf node into sub-cuboids;
obtaining the vertex information about the sub-cuboids to determine points of the point cloud.
obtaining the vertex information about the sub-cuboids to determine points of the point cloud comprising:

Preferably, determining first centroid position based on the positions of vertices of first sub-cuboid of the leaf node, wherein the sub-cuboids including the first sub-cuboid; reconstructing first triangle based on vertices of first sub-cuboid and first centroid position; performing voxelization of reconstructed triangles to determine points of the point cloud, wherein reconstructed triangles including the first triangle.

Preferably, determining first centroid position based on the positions of vertices of first sub-cuboid of the leaf node comprising: determining a virtual position based on the positions of vertices of one first sub-cuboid of the leaf node; constructing second triangles based on the vertices of one first sub-cuboid and the virtual position; determining a normal vector of the first sub-cuboid based on the constructed second triangle; determining first centroid position based on the virtual position and the normal vector.

Thus, in a first step a bitstream is received and the bitstream may contain information regarding the octree structure of the volume of the point cloud which may be decoded.

Preferably, the geometry of the Point cloud is GPCC-encoded. Thus, preferably by decoding from the bitstream the octree information about the volume of the point could is provided. Further, the bitstream includes vertex information including position of a vertex on edges of the cuboids relating to leaf nodes in the octree structure. Preferably, further including information about vertex presence. Thus, the vertex information may be provided by receiving and/or decoding the bitstream. Therein the bitstream is preferably encoded by a TriSoup encoding scheme at the encoder.

After receiving and/or decoding vertex information, preferably also the octree information from the bitstream which is described in previous one step, in a further step, for reconstructing the point cloud geometry, triangles may be determined for each cuboid according to Trisoup coding. Therein, Trisoup coding is a geometry coding option in which G-PCC encoder may represent an object's surface captured in the point cloud as a series of triangle meshes. Trisoup coding is typically useful for dense surface point clouds. The decoder, e.g., G-PCC decoder, may reconstruct a point cloud from the mesh surface with a specified voxel granularity. In particular, a virtual position may be first determined based on the positions of vertices of one cuboid relating to a leaf node of the octree structure, preferably by averaging the positions of vertices of one cuboid. Then, a first set of triangles may be constructed based on the vertices of one cuboid and the virtual position, preferably by connecting clockwise two consecutive vertices on the edges of a cuboid and the determined virtual position. Thus, the surfaces of the first set triangles are determined by the position of the vertices included in the bitstream and the determined virtual position (i.e., mean position of the vertices).

Subsequently, a normal vector of the cuboid may be determined based on the constructed triangle. Therein, a normal vector is a vector that is perpendicular to a given object. Thus, the normal vector of each of the first set of triangles can be determined respectively. Then, the normal vector of the cuboid may be determined based on the sum of the determined normal vectors of the first set of the triangles. Then a centroid position may be determined based on the virtual position and the normal vector of the cuboid. With such adjustment, the determined centroid position might be closer to the original positions of the point cloud in the leaf node. The triangles may be then constructed according to the adjusted vertices and the centroid in a similar manner as previously described.

In order to reconstruct the points of the point cloud from the reconstructed triangles, voxelization may be performed, preferably by a ray-tracing process wherein in the ray-tracing process rays are launched along the three directions parallel to any of the three axes. Their origin is a point of integer coordinates corresponding to the sampling precision wanted for the rendering. The intersection point (if any) of the ray with one of the reconstructed triangles may be then determined and added to the list of rendered points, i.e., added to the points of the point cloud. The surface of the reconstructed triangles is sampled by the rays during voxelization in order to determine the points of point cloud.

According to conventional trisoup coding, if the number of vertices in a leaf node is less than 3, the no triangle will be constructed. However, in some cases, although there are less than 3 vertices in a leaf node, there might still be a surface in the corresponding area of the leaf node (e.g., texture area). Thus, according to the method of the present disclosure, the compression efficiency of the conventional trisoup coding can be improved by further split such leaf node into smaller sub-cuboids for further processing.

Preferably, the leaf node is split if the number of vertices in the leaf node is less than 3 . . . . Thus, by setting such a condition, textured surface may be identified so that further processing of the current leaf node may be performed. In addition, no extra bit is introduced in the bitstream and therefore, the compression efficiency can be improved without sacrificing the processing efficiency.

Preferably, the sub-cuboids are processed in a raster scan order, ensuring an orderly and efficient processing method.

In another aspect of the present disclosure a method for encoding a 3D point cloud into a bitstream is provided preferably implemented in an encoder. The method for encoding the 3D point cloud includes:
obtaining vertex information from surfaces of the point cloud for each cuboid relating to a leaf node, wherein the vertex information includes the position of a vertex on edges of the cuboid and the vertex information includes information about sub-cuboids to determine points of the point cloud;
splitting the leaf node into the sub-cuboids to determine the information about the sub-cuboids;
encoding the vertex information into a bitstream.

Thus, by the method for encoding, the vertex information and preferably the octree information are generated. This information may be encoded into the bitstream. Subsequently at the encoder side, a reconstruction step may be performed. In this reconstruction step the point cloud geometry information is reconstructed, wherein the steps of reconstructing are the same as that in the method for decoding as described above. The reconstructed geometry of point cloud at the encoder side is then used to encode attributes (color, reflectance . . . ) of the points of the point cloud for example by RAHT (Region-Adaptive Hierarchical Transform), predicting transform or lifting transform being used in order to encode the attributes of the points of the point cloud.

Preferably, geometry of the point cloud is encoded into the bitstream by Geometry-based Point Cloud Compression (G-PCC).

Preferably, the bitstream is an MPEG G-PCC compliant bitstream.

Preferably, another additional information indicating whether to enable the proposed method may be encoded into the bitstream. For example, a flag textured_area improve_enable to control the enabling/disabling of the proposed method for coding of point cloud with texture area, which can add the flexibility of usage of the proposed method. If the flag textured_area_improve_enable is true, then the proposed method, which is described above, enabled, otherwise the proposed method is disabled. And at encoder side, such additional information may be put into GPS (Geometry parameter set) and encoded into bitstream; and at decoder, such information, e.g., the flag textured_area_improve_enable may be decoded from bitstream and then it is put into GPS.

Preferably, the method for encoding is further built according to the features described before in connection with the method for decoding.

In another aspect of the present disclosure an encoder is provided for encoding a 3D point cloud into a bitstream. The encoder comprises a memory and a processor, wherein instructions are stored in the memory, which when executed by the processor perform the steps of the method for encoding described before.

In another aspect of the present disclosure a decoder is provided for decoding a 3D point cloud from a bitstream. The decoder comprises a memory and a processor, wherein instructions are stored in the memory, which when executed by the processor perform the steps of the method for decoding de-scribed before.

In another aspect of the present disclosure a bitstream is provided, wherein the bitstream is encoded by the steps of the method for encoding described before.

In another aspect of the present disclosure a computer-readable storage medium is provided comprising instructions to perform the steps of the method for encoding a 3D point cloud into a bitstream as described above.

In another aspect of the present disclosure a computer-readable storage medium is provided comprising instructions to perform the steps of the method for decoding a 3D point cloud from a bitstream as described above.

### BRIEF DESCRIPTION OF DRAWINGS

In the following the present disclosure is described in more detail with reference to the accompanying figures.

The figures show:

FIG. 1 a flow diagram of the method for decoding a 3D point cloud geometry according to the present disclosure,

FIG. 2 an example for generation of the octree structure,

FIG. 3 an octree according to FIG. 2,

FIG. 4 an example for determining vertices on edges of a cuboid,

FIG. 5 an example for generating triangles,

FIG. 6 an example of vertices on the edges of a cuboid,

FIG. 7 a generation of the triangle by vertices,

FIG. 8 an example of determining the order of the triangles according to FIG. 7,

FIG. 9 a schematic drawing for the step of voxelization,

FIG. 10 an example of reconstruction of triangles using the centroid point C as a pivoting point,

FIG. 11 an example of normal vector,

FIG. 12 an example of a 1D residual along the normal vector,

FIG. 13A an example of original point cloud,

FIG. 13B an example of a compressed point cloud,

FIG. 14A an example of a textured surface,

FIG. 14B an example of determined vertices,

FIG. 15 an example of a leaf node to be divided,

FIG. 16 an example of the constructed triangles of sub-cuboids,

FIG. 17 an example of raster scan order,

FIG. 18 a decoder or encoder according to the present disclosure.

### DETAILED DESCRIPTION

As a format for the representation of 3D data, point clouds have recently gained traction as they are versatile in their capability in representing all types of 3D objects or scenes.

Therefore, many use cases can be addressed by point clouds, among which are
movie post-production,
real-time 3D immersive telepresence or VR/AR applications,
free viewpoint video (for instance for sports viewing),
Geographical Information Systems (aka cartography),
culture heritage (storage of scans of rare objects into a digital form),
Autonomous driving, including 3D mapping of the environment and real-time Lidar data acquisition

A point cloud is a set of points located in a 3D space, optionally with additional values attached to each of the points. These additional values are usually called point attributes. Consequently, a point cloud is a combination of a geometry (the 3D position of each point) and attributes.

Attributes may be, for example, three-component colours, material properties like reflectance and/or two-component normal vectors to a surface associated with the point.

Point clouds may be captured by various types of devices like an array of cameras, depth sensors, Lidars, scanners, or may be computer-generated (in movie post-production for example). Depending on the use cases, points clouds may have from thousands to up to billions of points for cartography applications.

Raw representations of point clouds require a very high number of bits per point, with at least a dozen of bits per spatial component X, Y or Z, and optionally more bits for the attribute(s), for instance three times 10 bits for the colours. Practical deployment of point-cloud-based applications requires compression technologies that enable the storage and distribution of point clouds with reasonable storage and transmission infrastructures.

Compression may be lossy (like in video compression) for the distribution to and visualization by an end-user, for example on AR/VR glasses or any other 3D-capable device. Other use cases do require lossless compression, like medical applications or autonomous driving, to avoid altering the results of a decision obtained from the analysis of the compressed and transmitted point cloud.

Until recently, point cloud compression (aka PCC) was not addressed by the mass market and no standardized point cloud codec was available. In 2017, the standardization working group ISO/JCT1/SC29/WG11, also known as Moving Picture Experts Group or MPEG, has initiated work items on point cloud compression. This has led to two standards, namely
MPEG-I part 5 (ISO/IEC 23090-5) or Video-based Point Cloud Compression (V-PCC)
MPEG-I part 9 (ISO/IEC 23090-9) or Geometry-based Point Cloud Compression (G-PCC)

Both V-PCC and G-PCC standards have finalized their first version in late 2020.

The V-PCC coding method compresses a point cloud by performing multiple projections of a 3D object to obtain 2D patches that are packed into an image (or a video when dealing with moving point clouds). Obtained images or videos are then compressed using already existing image/video codecs, allowing for the leverage of already deployed image and video solutions. By its very nature, V-PCC is efficient only on dense and continuous point clouds because image/video codecs are unable to compress non-smooth patches as would be obtained from the projection of, for example, Lidar-acquired sparse geometry data.

The G-PCC coding method has two schemes for the compression of the geometry. The first scheme is based on an occupancy tree (octree/quadtree/binary tree) representation of the point cloud geometry. Occupied nodes are split down until a certain size is reached, and occupied leaf nodes provide the location of points, typically at the centre of these nodes. By using neighbour-based prediction techniques, high level of compression can be obtained for dense point clouds. Sparse point clouds are also addressed by directly coding the position of point within a node with non-minimal size, by stopping the tree construction when only isolated points are present in a node; this technique is known as Direct Coding Mode (DCM).

The second scheme is based on a predictive tree, each node representing the 3D location of one point and the relation between nodes is spatial prediction from parent to children. This method can only address sparse point clouds and offers the advantage of lower latency and simpler decoding than the occupancy tree. However, compression performance is only marginally better, and the encoding is complex, relatively to the first occupancy-based method, intensively looking for the best predictor (among a long list of potential predictors) when constructing the predictive tree.

In both schemes, attribute (de)coding is performed after complete geometry (de)coding, leading to a two-pass coding. Thus, low latency is obtained by using slices that decompose the 3D space into sub-volumes that are coded independently, without prediction between the sub-volumes. This may heavily impact the compression performance when many slices are used.

An important use case is the transmission of dynamic AR/VR point clouds. Dynamic means that the point cloud evolves with respect to time. Also, AR/VR point clouds are typically locally 2D as they most of time represent the surface of an object. As such, AR/VR point clouds are highly connected (or said to be dense) in the sense that a point is rarely isolated and, instead, has many neighbours.

Dense (or solid) point clouds represent continuous surfaces with a resolution such that volumes (small cubes called voxels) associated with points touch each other without exhibiting any visual hole in the surface.

Such point clouds are typically used in AR/VR environments and are viewed by the end user through a device like a TV, a smartphone or a headset. They are transmitted to the device or stored locally. Many AR/VR applications use moving point clouds, as opposed to static point clouds, that vary with time. Therefore, the volume of data is huge and must be compressed. Nowadays, lossless compression based on an octree representation of the geometry of the point cloud can achieve down to slightly less than a bit per point (1 bpp). This may not be sufficient for real time transmission that may involve several millions of points per frame with a frame rate as high as 50 frames per second (fps), thus leading to hundreds of megabits of data per second. Consequently, lossy compression may be used with the usual requirement of maintaining an acceptable visual quality while compressing sufficiently to fit within the bandwidth provided by the transmission channel while maintaining real time transmission of the frames. In many applications, bitrates as low as 0.1 bpp (10× more compressed than lossless coding) would already make possible real time transmission.

The codec VPCC based on MPEG-I part 5 (ISO/IEC 23090-5) or Video-based Point Cloud Compression (V-PCC) can achieve such low bitrates by using lossy compression of video codecs that compress 2D frames obtained from the projection of the point cloud on a plane. The geometry is represented by a series of projection patches assembled into a frame, each patch being a small local depth map. However, VPCC is not versatile and is limited to a narrow type of point clouds that do not exhibit locally complex geometry (like trees, hair) because the obtained projected depth map would not be smooth enough to be efficiently compressed by a video codec.

Purely 3D compression techniques can handle any type of point clouds. It is still an open question whether 3D compression techniques can compete with VPCC (or any projection+image coding scheme) on dense point clouds. Standardization is still under its way toward offering an extension (an amendment) of GPCC that would provide competitive lossy compression that would compress dense point clouds as good as VPCC intra while maintaining the versatility of GPCC that can handle any type of point clouds (dense, Lidar, 3D maps). This extension is likely to use the so-called TriSoup coding scheme that works over to an octree, as detailed in next sections. TriSoup is under exploration in the standardization working group JTC1/SC29/WG7 of ISO/IEC.

Referring to FIG. 1 showing a schematic diagram for the method of decoding geometry information of a 3D point cloud from a bitstream.

The method for decoding geometry of a 3D point cloud from a bitstream, preferably implemented in a decoder, includes the steps:
S11: receiving a bitstream, wherein the bitstream contains vertex information including information about position of a vertex on edges of cuboids of leaf nodes of the octree structure of the point cloud;
S12: splitting the leaf node into sub-cuboids;
S13: obtaining the vertex information about the sub-cuboids to determine points of the point cloud.

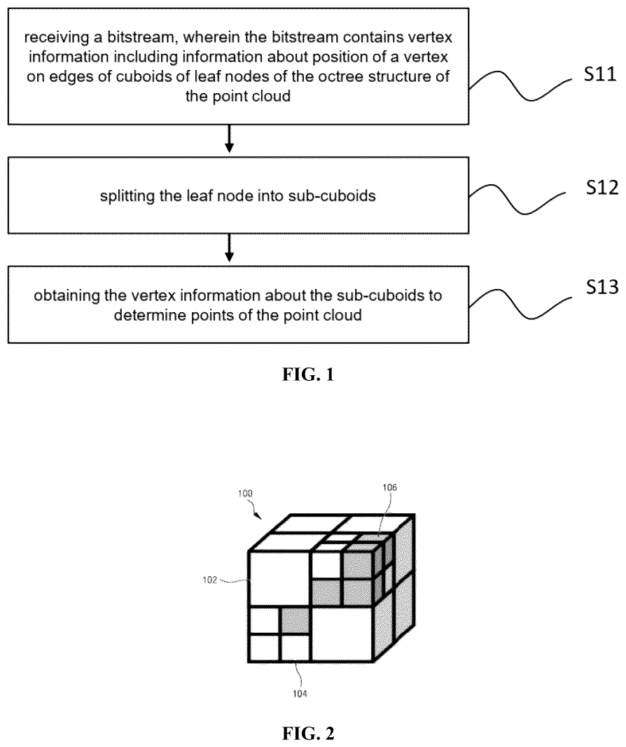

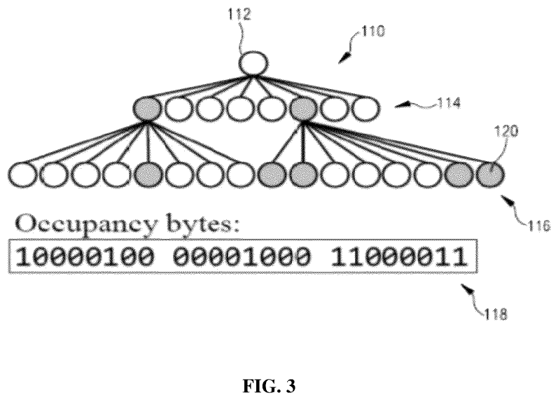

The first step of the geometry encoding process in order to determine the octree information is to build and encode an octree, as illustrated in FIGS. 2 and 3. The bounding box is the main volume 100 that contains all the points, and is associated to the root node 112 (i.e. single node at the top of the tree 110). This volume 100 is first divided into 8 sub-volumes 102 called octants, each is represented by a node 114 in the tree 110. The octants 106 that are occupied by at least one point, which are shaded in FIGS. 2 and 3, are then recursively split in sub-volumes 104 until a target level is reached. The target level is a level that the volumes shall not be split anymore, and it may be determined based on the compression rate.

Each octant (or node) is represented by an occupancy byte that contains one bit per child octant, set to one if it is occupied by at least one point, or to zero otherwise. The occupancy bytes 118 such as “1000100 00001000 11000011” of all the octants are serialized (in breadth-first order) and entropy coded with a binary arithmetic encoder.

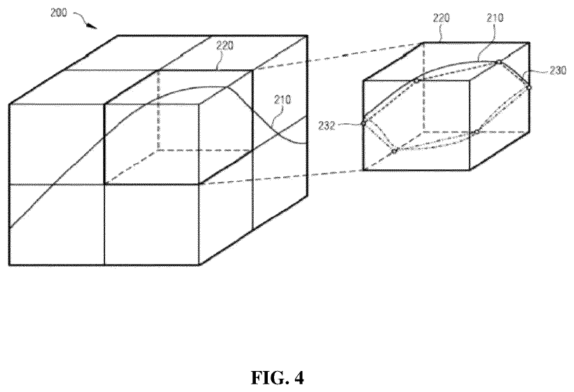

FIG. 4 illustrates a blocking representation of a 3D surface 210, as well as an example of a block 220 in a TriSoup. The surface 210 intersects the block 220, which is therefore an occupied block, and the block 220 exists among multiple blocks 200 in 3D space. Within the block 220, the enclosed portion of the surface 210 intersects the edges of the block at six illustrated vertices 232 of a polygon 230. An edge of the block 220 is said to be selected if it contains a vertex.

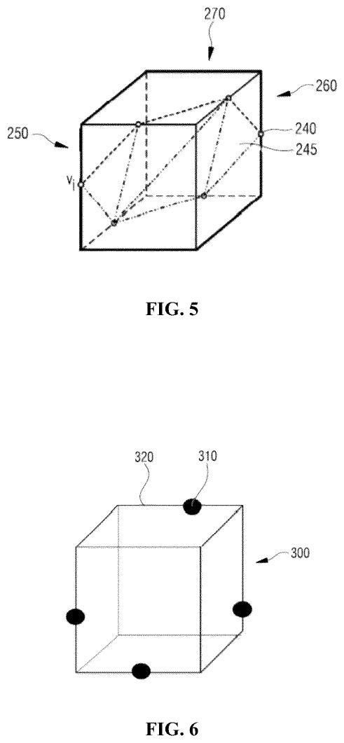

FIG. 5 illustrates the block 220 in the TriSoup, omitting the surface 210 for clarity, and showing a non-selected edge 270, a selected edge 260, and the ith edge 250. Suppose the ith edge 250 is selected. To specify a vertex vi on edge i, one specifies a scalar value to indicate a corresponding fraction of the length of the edge 250.

As illustrated in FIGS. 4 and 5, within each octant 220 in the target level of the octree, the trisoup represents the original surface 210 as a set of triangles 245. This surface is encoded and used to obtain the positions of the recon-structed (or decoded) points. First, the intersections of the surface represented by the original points with the edges of the octants are estimated by averaging the positions of the points that are the closest to those edges within the octant. Secondly, the twelve edges of all the octants and their associated intersections (if any) are stored as segments and vertices respectively. Each (unique) segment is then encoded as follows. A first single bit is arithmetically coded, set to one if the segment is occupied by a vertex and zero otherwise. If it is occupied, the relative position of the vertex on the segment is also arithmetically coded.

Vertices 310 of triangles are coded along the edges 320 of volumes associated with leaf nodes 300 of the tree, as depicted on FIG. 6. These vertices 310 on edge 320 are shared among leaf nodes 300 having a common edge 320. This means that at most one vertex is coded per edge belonging to at least one leaf node. By doing so, continuity of the model is ensured through leaf nodes.

As mentioned above, the encoding of the TriSoup vertices requires two information per edge: a vertex flag indicating if a TriSoup vertex is present on the edge, and when present, the vertex position along the edge.

Consequently, the coded data consists in the octree data plus the TriSoup data.

The vertex flag is coded by an adaptive binary arithmetic coder that uses one specific context for coding vertex flags. The position of a vertex on an edge of length N=2\hat{ }s might be coded with unitary precision by pushing (bypassing/not entropy coding) s bits into the bitstream.

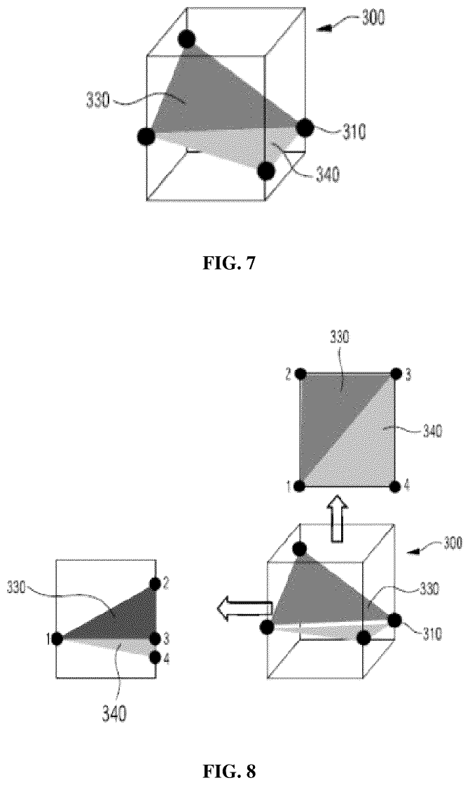

Inside a leaf node, triangles are constructed from the TriSoup vertices if at least three vertices 310 are present on the edges 320 of the leaf node 300. Reconstructed triangles 330, 340 are depicted in FIG. 7.

Obviously, other combinations of triangles 330, 340 are possible. The choice of triangles comes from a three-step process
1. determining a dominant direction along one of the three axes
2. ordering TriSoup vertices depending on the dominant direction
3. constructing triangle based on the ordered list of vertices

Knowledge about the exact position of the triangles within the current leaf is not necessary and can be deduced from the vertices.

FIG. 8 will be used to explain this process. Each of the three axis is tested and the one maximizing the total surfaces of triangle is kept as dominant axis. For simplicity of the figure, only the test over two axis is depicted on FIG. 8.

A first test (top) along the vertical axis is performed by projecting the cube and the Trisoup vertices 310 vertically on a 2D plane. The vertices 310 are then ordered following a clockwise order relative to the center of the projected node (a square). Then, triangles 330, 340 are constructed following a fixed rule based on the ordered vertices. Here, triangles 123 and 134 are constructed systematically when 4 vertices are involved. When 3 vertices are present, the only possible triangle is 123. When 5 vertices are present, a fixed rule may be to construct triangles 123, 134 and 451. And so on, up to 12 vertices.

A second test (left) along a horizontal vertical axis is performed by projecting the cube and the Trisoup vertices horizontally on a 2D plane.

The vertical projection exhibits the 2D total surface of triangles that is maximum, thus the dominant axis is selected as vertical, and the constructed TriSoup triangles are obtained from the order of the vertical projection, as in FIG. 8 inside the node. It is to be noted that taking the horizontal axis as dominant would have led to another construction of triangles.

The adequate selection of the dominant axis by maximizing the projected surface leads to a continuous reconstruction of the point cloud without holes.

The rendering of TriSoup triangles into points is performed by ray tracing. The set of all rendered points by ray tracing will make the decoded point cloud.

For ray tracing as shown in FIG. 9, rays are launched along the three directions parallel to an axis. Their origin is a point of integer (voxelized) coordinates of precision corresponding to the sampling precision wanted for the rendering. The intersection (if any, dashed point) with one of the Trisoup triangles is then voxelized (=rounded to the closest point at the wanted sampling precision) and added to the list of rendered points.

After applying Trisoup to all leaf nodes, i.e., constructing triangles and obtaining points by ray tracing, copies of same points in the list of all rendered points are discarded (i.e. only one voxel is kept among all voxels sharing the same position and volume) to obtain a set of decoded (unique) points.

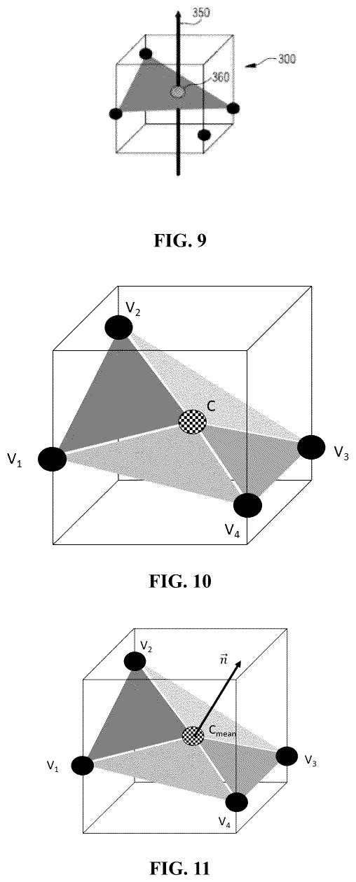

Based on the above deprescribed basic concepts, improvements might be applied to the Trisoup coding. For example, by computing a centroid point whose coordinates are the mean coordinates of all (ordered) vertices Vi, see FIG. 10 where the centroid point C is depicted using checkboard filling. The centroid point is used as a pivoting point. The triangle are constructed from the ordered vertices (V₁, V₂, . . . , V_{M}) by pivoting around the centroid point C. The following M triangles are constructed: V₁V₂C, V₂V₃C, . . . , V_{M-1}VMC, VMV1C.

Therein, the vertices are ordered clockwise and is not important which of the vertices is chosen as V₁.

This construction preserves natural symmetries of the model without privileging arbitrary some triangles. Moreover, it provides an additional degree of freedom to improve the accuracy of the model, namely the position of the centroid point C.

Consequently, the position of the centroid point C might be further improved by coding a residual position in the bitstream such that the position centroid point Cis closer from original points of the point cloud.

For example, C=Cₘₑₐₙ+Cᵣₑₛ

where Cₘₑₐₙ is the mean position obtained by averaging coordinates of all (ordered) vertices, and Cᵣₑₛ is a coded residual.

The coded residual may be a 3D residual. However, it is observed that a 3D residual is rarely advantageous because it requires many bits to be coded and this many bits are not fully compensated by the better accuracy of the model. Therefore, it is preferred to code a 1D residual Cᵣₑₛ.

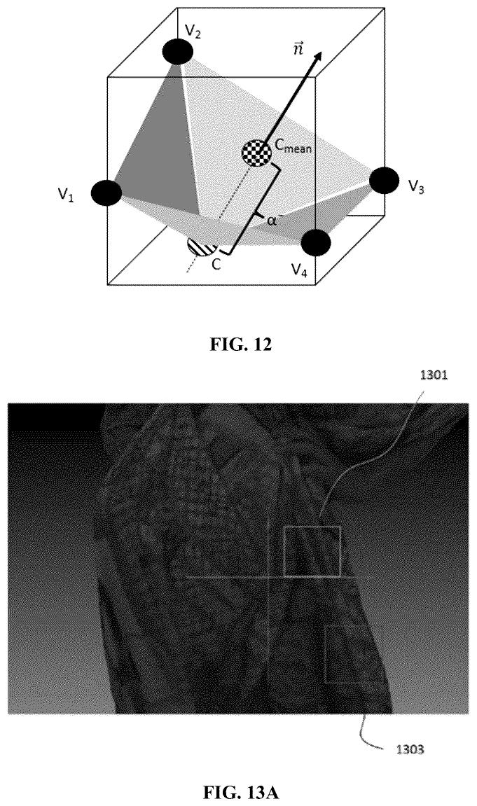

For example, a normal vector \vec{n} may be constructed, as shown in FIG. 11, and the residual may be determined by the following equation:

$${C}_{r e s} = {α}^{*} \vec{n}$$

where α is a 1D signed scalar value coded in the bitstream, see FIG. 12. The normal vector \vec{n} may be derived by the following two steps

$$1. \vec{m} = \vec{{E}_{1}} \times \vec{{E}_{2}} + … + \vec{{E}_{M - 1}} \times \vec{{E}_{M}} + \vec{{E}_{M}} \times \vec{{E}_{1}}$$

2, and then normalization \vec{n}=\vec{m}/√∥\vec{m}| where x is the cross product (also named vector (cross) product) between two vectors, and the edges \vec{Eⱼ} are:

$$\vec{{E}_{j}} = \vec{{V}_{j} {C}_{mean}} .$$

It will be understood that the vector \vec{n} may be taken parallel to an axis in order to simplify computation of its determination and the value α. The vector \vec{n} may be taken parallel to the dominant axis as a good approximation of the vector computed above. The value α is determined by the encoder, encoded into the bitstream and obtained by the decoder by decoding the bitstream. The value α may be binarized and each bit may be encoded by using a binary entropy coder such as an arithmetic coder or a context adaptive binary coder like CABAC.

The value α may be binarized into
a flag f₀ indicating if a is equal to 0,
a sign that indicates if α>0 or α<0,
a flag f₁ indicating if |α| is equal to 1,
a remainder |α|−2 coded by an expGolomb coder.

The value α may be determined by the encoder by considering all points Pₖ of the point cloud belonging to a current leaf node. For each point Pₖ, its distance dₖ from the line (Cₘₑₐₙ, \vec{n}) is found by

$${d}_{k} = ‖ \vec{n} \times \vec{{C}_{mean} {P}_{k}} ‖ ,$$

and in case this distance dₖ is below a pre-defined threshold th (e.g., th=2), the point Pₖ is used to compute the value α. The 1D residual rₖ of a point Pₖ relative to the mean point Cₘₑₐₙ is obtained by the scalar product (also named inner product or dot product)

$${r}_{k} = \vec{n} . \vec{{C}_{mean} {P}_{k}} .$$

The value α is thus obtained by

$$α = {Σ}_{{P}_{k} ∈ {S}^{r} k} / \vert S \vert$$

where S is the set of points Pₖ such that their distance dₖ is below the threshold th, and |S| is the number of points belonging to this set.

In current trisoup coding, as is described in relation to the previous figures, the determined centroid point C and vertices (V₀, . . . , Vᵢ) of a leaf node may be used to construct triangles, then a ray tracing method may be applied to the constructed triangles to get reconstructed points.

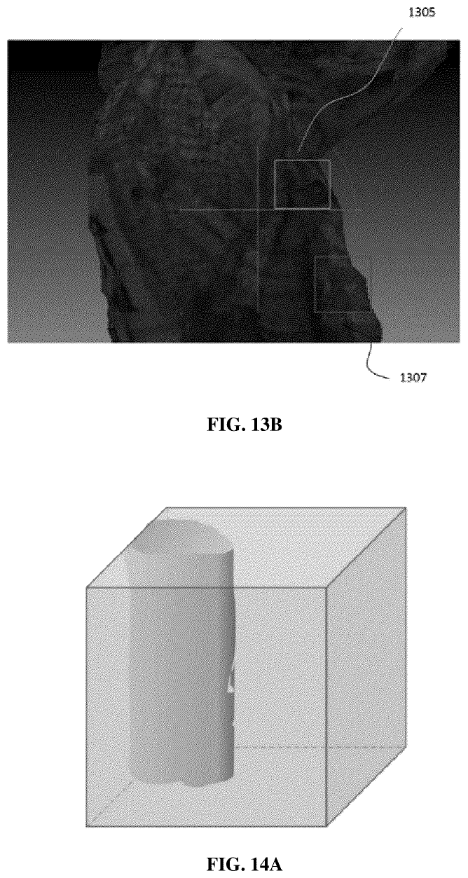

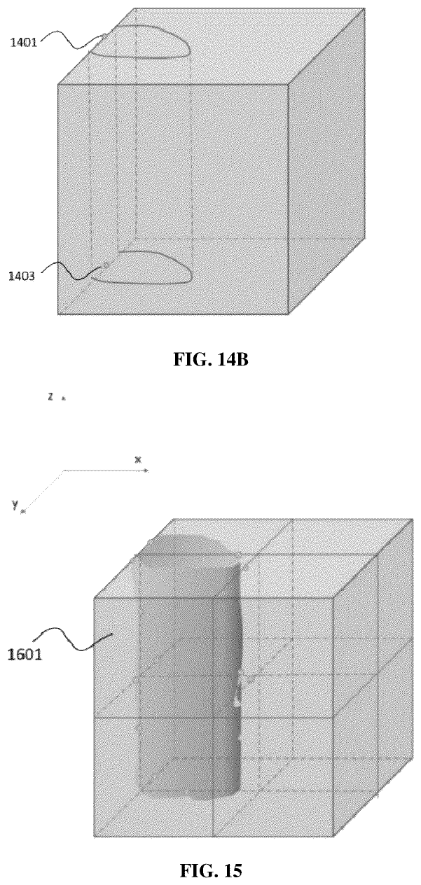

However, there is a problem in current trisoup coding that if there are less than 3 vertices in a leaf node, then no triangle will be constructed and so no points will be reconstructed in the leaf node. However, in some cases, although there are less than 3 vertices generated in a leaf node, there is still a surface in the corresponding area of original leaf node. For example, if a textured surface locates in a leaf node, which is shown in FIG. 13A rectangular 1301 and 1303, there are small concave and convex areas that are far away from edges of a leaf node, then less than 3 vertices may be determined in the vertices determination process, which can be illustrated in FIGS. 14A and 14B. FIG. 14A shows a texture surface and FIG. 14B shows the determined vertices 1401 and 1403. Therefore, no triangles and then no points will be reconstructed, that will cause the reconstructed quality error in such textured surface area, as shown in FIG. 13B, the clothes wrinkle is not correctly reconstructed at all. And such cases happen more often at lower compression rate, since the leaf node size at lower compression rate is larger than that at higher compression rate. And the problem will cause the compression efficiency of current trisoup coding for point cloud data is not optimal.

As is described above, the problem to be solved is to improve compression efficiency of current trisoup coding by improving the reconstructed point cloud quality in textured area, especially at lower compression rate.

To improve trisoup coding performance of point cloud data, it is proposed to use leaf nodes of variable sizes to model surfaces for trisoup coding. For point cloud data with textured areas, it is proposed to use nodes of smaller size to model surfaces of textured areas in point cloud data, and also to use additional information (e.g., a flag) to signal the use of the proposed method for corresponding leaf nodes where textured areas exist. The advantages of the proposed method are as follow: It can better model the surface of textured areas in original point cloud, and it can get better reconstructed points of textured areas, and miss less reconstructed points of textured areas in original point cloud, thus it can improve the quality of reconstructed point cloud, It can improve the compression efficiency of trisoup coding, especially at lower compression rate. And introduction of the flag adds the flexibility for users to decide if the proposed method is used for textured areas or not.

In preferred embodiments, the proposed trisoup coding method for point cloud data follows the steps:

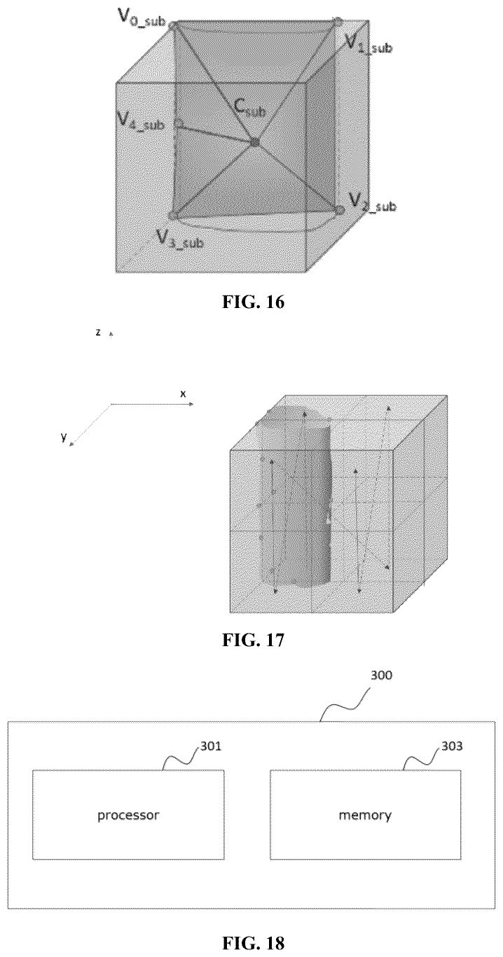

At decoder side, after octree decoding process finished, then it goes to the last depth constituting of leaf nodes and implements trisoup decoding for each leaf node iteratively. It decodes vertices Vᵢ of each leaf node from bitstream, then it iterates each leaf node to determine if the current leaf node need to be divided into smaller sub-cubes or not (that means if current leaf node contains textured area), and during this procedure, the proposed method is used. To be detail, for each leaf node:
Firstly, it may use the number Nv of vertices Vᵢ as a condition to determine if current leaf node need to be divided into smaller sub-cubes or not,
if Nv<3, then the leaf node may be divided into smaller sub-cubes. And then sub-cube vertices V_{i_sub} for corresponding sub-cubes may be decoded from the bitstream, and information of sub-cube centroid points C_{sub} of corresponding sub-cubes may also be decoded from the bitstream.
Otherwise, if Nv>=3, then the leaf node may not need to be divided into smaller sub-cubes, and it may decode information of centroid point C from bitstream, and no sub-cube vertices V_{i_sub} and sub-cube centroid points C_{sub} may be decoded.
After getting information of vertices (including vertices Vᵢ and sub-cube vertices V_{i_sub}) and centroid point (including centroid point C and sub-cube centroid points C_{sub}), then it constructs triangles for the leaf node based on vertices and centroid point determined in the leaf node, which includes constructing smaller triangles in sub-cubes of the leaf node if sub-cubes are created, and then may apply ray tracing method onto these constructed triangles to reconstruct point cloud data. To be detail, if current leaf node is divided into smaller sub-cubes (for example, as is shown in FIG. 15, the leaf node can be divided into 8 sub-cubes by splitting the leaf node into two equal parts along each coordinate), smaller triangles based on vertices V_{i_sub} and centroid points C_{sub} in sub-cubes are constructed (as is shown in FIG. 16, wherein it shows triangles constructed in the front-top-left sub-cube of leaf node 1601 in FIG. 15, and the triangles are constructed based on sub-cube vertices V_{0_sub}, V_{1_sub}, V_{2_sub}, V_{3_sub}, V_{4_sub}, and sub-cube centroid point C_{sub} of the sub-cube), and ray tracing method may be applied on each triangle; otherwise, if the current leaf node is not divided into smaller sub-cubes, it constructs triangles in the leaf node, and then may apply ray tracing method on each triangle to reconstruct point cloud data.

At encoder side, after octree encoding process is finished, then it may go to the last depth constituting of leaf nodes and implements trisoup encoding for each leaf node iteratively. It may determine the vertices Vᵢ for edges of each leaf node according to points in the leaf node, then then it may iterate each leaf node to judge if surface in the leaf node is textured area or not to better encode points in the leaf node, and during this process, the proposed method for textured areas may be used. To be detail, for each leaf node:

1. Firstly, it may determine if surface in the leaf node is textured area to better model surface in the leaf node. The determination of surface in the leaf node being textured area may depend on a condition: the number Nv of determined vertices for the leaf node is less than 3, preferably less than 2. Firstly, it judges the condition, and if the condition is true (Nv<3), then surface in the leaf node is textured area, because in trisoup coding each leaf node contains points; and then the leaf node is further divided into smaller cubes, and sub-cube vertices V_{i_sub} and sub-cube centroid points C_{sub} may be determined within sub-cubes.
For example, the leaf node can be divided into 8 sub-cubes by splitting the leaf node into two parts along each coordinate, as is shown in FIG. 15. And then, it iterates each sub-cube, by an order, to determine the sub-cube vertices V_{i_sub} of corresponding edges of sub-cubes and sub-cube centroid point C_{sub} of each sub-cube (if there are points in the sub-cube).
if the condition is not true (Nv>=3), then it may determine centroid point C, and no sub-cube vertices and sub-cube centroid point may be determined.

2. Then, the determined vertices (including vertices Vᵢ in leaf nodes and sub-cube vertices V_{i_sub} in sub-cubes), and information of determined centroid point C in leaf node and determined sub-cube centroid point C_{sub} of sub-cubes of the leaf node may be encoded into the bitstream.

3. Then, it may iterate each leaf node to get reconstructed point cloud data by constructing triangles and preferably implementing ray tracing method onto these triangles.
If the number Nv of determined vertices for the leaf node is not less than 3, then triangles are constructed same as that in related art, and ray tracing method is applied to these leaf nodes to get reconstructed points;
and if the number Nv of determined vertices for the leaf node is less than 3, based on the decoded vertices V_{i_sub} and centroid point C_{sub} in sub-cubes, then smaller triangles are constructed in corresponding sub-cubes of the leaf node, as shown in FIG. 16, wherein it shows triangles constructed in the front-top-left sub-cube of leaf node 1601 in FIG. 15, and the triangles are constructed based on sub-cube vertices V_{0_sub}, V_{1_sub}, V_{2_sub}, V_{3_sub}, V_{4_sub}, and sub-cube centroid point C_{sub} of the sub-cube, and then ray tracing method may be applied to these triangles to get reconstructed points.

In some embodiments, the proposed method also includes information indicating whether to enable the proposed method, for example, a flag textured_area_improve_enable to control the enabling/disabling of the proposed method for coding of point cloud with texture area, which can add the flexibility of usage of the proposed method. If the flag textured_area_improve_enable is true, then the proposed method, which is described above, may be enabled, otherwise the proposed method may be disabled. And at encoder side, the flag textured_area_improve_enable may be put into GPS (Geometry parameter set) and encoded into bitstream; and at decoder, the flag textured_area_improve_enable is decoded from bitstream and the it is put into GPS (Geometry parameter set).

In some embodiments, if the condition is true (Nv<3), then the leaf node may be divided into 8 cub-cubes, and then it may iterate each sub-cube to determine their vertices V_{i_sub} and centroid point C_{sub} by an order. The order may be in raster scan order, which is an order follows a lexicographic order but in the three dimensions x, y, and z of sub-cubes, for instance a lexicographic order in (z, y, x) may be used, which is shown in FIG. 17. For each sub-cube, it may iterate each edge of the sub-cube to find points P within it that are close to the edge, and then determine the position of vertex along the edge by calculating the mean position of these points. Reference is now made to FIG. 18, which shows a simplified block diagram of an example embodiment of an encoder or decoder 300. The encoder or decoder 300 includes a processor 301 and a memory storage device 303. The memory storage device 303 may store a computer program or application containing instructions that, when executed, cause the processor 301 to perform operations such as those described herein. For example, the instructions may encode and output bitstreams encoded or decode bitstreams and output points of a point cloud in accordance with the methods described herein. It will be understood that the instructions may be stored on a non-transitory computer-readable medium, such as a compact disc, flash memory device, random access memory, hard drive, etc. When the instructions are executed, the processor 301 carries out the operations and functions specified in the instructions so as to operate as a special-purpose processor that implements the described process(es). Such a processor may be referred to as a “processor circuit” or “processor circuitry” in some examples.

It will be appreciated that the decoder and/or encoder according to the present disclosure may be implemented in a number of computing devices, including, without limitation, servers, suitably programmed general purpose computers, machine vision systems, and mobile devices. The decoder or encoder may be implemented by way of software containing instructions for configuring a processor or processors to carry out the functions described herein. The software instructions may be stored on any suitable non-transitory computer-readable memory, including CDs, RAM, ROM, Flash memory, etc.

It will be understood that the decoder and/or encoder described herein and the module, routine, process, thread, or other software component implementing the described method/process for configuring the encoder or decoder may be realized using standard computer programming techniques and languages. The present disclosure is not limited to particular processors, computer languages, computer programming conventions, data structures, other such implementation details. Those skilled in the art will recognize that the described processes may be implemented as a part of computer-executable code stored in volatile or non-volatile memory, as part of an application-specific integrated chip (ASIC), etc.

Certain adaptations and modifications of the described embodiments can be made. Therefore, the above discussed embodiments are considered to be illustrative and not restrictive. In particular, embodiments can be freely combined with each other.

1. A method for decoding, from a bitstream, a geometry of a 3D point cloud, implemented in a decoder, the method comprising:
receiving the bitstream, wherein the bitstream contains vertex information including information about a position of a vertex on edges of cuboids of leaf nodes of an octree structure of the point cloud;
splitting a leaf node into sub-cuboids; and
obtaining the vertex information about the sub-cuboids to determine points of the point cloud.

2. The method according to claim 1, wherein obtaining the vertex information about the sub-cuboids to determine points of the point cloud comprises:
determining a first centroid position based on positions of vertices of a first sub-cuboid of the leaf node, wherein the sub-cuboids include the first sub-cuboid;
reconstructing a first triangle based on vertices of the first sub-cuboid and the first centroid position; and
performing voxelization of reconstructed triangles to determine points of the point cloud, wherein the reconstructed triangles include the first triangle.

3. The method according to claim 2, wherein determining the first centroid position based on the positions of vertices of the first sub-cuboid of the leaf node comprises:
determining a virtual position based on the positions of vertices of the first sub-cuboid of the leaf node;
constructing a second triangle based on the vertices of the first sub-cuboid and the virtual position;
determining a normal vector of the first sub-cuboid based on the constructed second triangle; and
determining the first centroid position based on the virtual position and the normal vector.

4. The method according to claim 1, wherein the leaf node is split if the number of vertices in the leaf node is less than 3.

5. The method according to claim 1, wherein the sub-cuboids are processed in a raster scan order.

6. The method according to claim 2, wherein the bitstream further contains an additional value and the first centroid position is further determined based on the additional value.

7. A method for encoding a 3D point cloud into a bitstream, implemented in an encoder, the method comprising:
obtaining vertex information from surfaces of the point cloud for each cuboid relating to a leaf node, wherein the vertex information includes a position of a vertex on edges of the cuboid and the vertex information includes information about sub-cuboids to determine points of the point cloud;
splitting the leaf node into the sub-cuboids to determine the information about the sub-cuboids; and
encoding the vertex information into the bitstream.

8. The method according to claim 7, wherein determining the points of the point cloud comprises:
determining a first centroid position based on positions of vertices of a first sub-cuboid of the leaf node, wherein the sub-cuboids include the first sub-cuboid;
reconstructing a first triangle based on the vertices of the first sub-cuboid and the first centroid position; and
performing voxelization of reconstructed triangles to determine the points of the point cloud, wherein the reconstructed triangles include the first triangle.

9. The method according to claim 8, wherein determining the first centroid position based on the positions of vertices of the first sub-cuboid of the leaf node comprises:
determining a virtual position based on the positions of vertices of the first sub-cuboid of the leaf node;
constructing a second triangle based on the vertices of the first sub-cuboid and the virtual position;
determining a normal vector of the first sub-cuboid based on the constructed second triangle; and
determining the first centroid position based on the virtual position and the normal vector.

10. The method according to claim 7, wherein the leaf node is split if the number of vertices in the leaf node is less than 3.

11. The method according to claim 7, further comprising:
determining an additional value; and encoding the additional value into the bitstream; wherein the first centroid position is further determined based on the additional value.

12. An encoder to encode a 3D point cloud into a bitstream, comprising:
at least one processor; and
a memory storing instructions executable by the processor,
wherein the processor is configured to perform the method according to claim 7.

13. A decoder to decode a 3D point cloud from a bitstream, comprising:
at least one processor; and
a memory storing instructions when executed executable by the processor,
wherein the processor is configured to:
receive the bitstream, wherein the bitstream contains vertex information including information about a position of a vertex on edges of cuboids of leaf nodes of an octree structure of the point cloud;
split a leaf node into sub-cuboids; and
obtain the vertex information about the sub-cuboids to determine points of the point cloud.

14. (canceled)

15. A non-transitory computer-readable storage medium storing instructions that, when executed by a processor, cause the processor to perform the method according to claim 1.

16. The decoder according to claim 13, wherein the processor is further configured to:
determine a first centroid position based on positions of vertices of a first sub-cuboid of the leaf node, wherein the sub-cuboids include the first sub-cuboid;
reconstruct a first triangle based on the vertices of the first sub-cuboid and the first centroid position; and
perform voxelization of reconstructed triangles to determine points of the point cloud, wherein the reconstructed triangles include the first triangle.

17. The decoder according to claim 16, wherein the processor is further configured to:
determine a virtual position based on the positions of the vertices of the first sub-cuboid of the leaf node;
construct a second triangle based on the vertices of the first sub-cuboid and the virtual position;
determine a normal vector of the first sub-cuboid based on the constructed second triangle; and
determine the first centroid position based on the virtual position and the normal vector.

18. The decoder according to claim 13, wherein the leaf node is split if the number of vertices in the leaf node is less than 3.

19. The decoder according to claim 13, wherein the sub-cuboids are processed in a raster scan order.

20. The decoder according to claim 16, wherein the bitstream further contains an additional value and the first centroid position is further determined based on the additional value.
